(19) United States
(12) Patent Application Publication
(10) Pub. No.: US 2004/0221423 A1
(43) Pub. Date: Nov. 11, 2004

(54) Office chair caster with a structural improvement

(76) Inventor: Po-Chuan Tsai, Tainan Hsien (TW)

Correspondence Address: Po-Chuan Tsai, P.O. Box 90, Tainan City, 704, TW

(21) Appl. No.: 10/434,189

(22) Filed: May 9, 2003

(51) Int. Cl. B60B 33/00

(52) U.S. Cl. 16/30

(57) ABSTRACT

An office chair caster with a structural improvement in the invention mainly has a wheel holder, a wheel and a wheel axle. Extend the wheel axle through a through hole of the wheel, and then place the wheel in an open slot of the wheel holder to make both ends of the wheel axle respectively slide upwards from lower ends of two slide ways of two clamp plates of the wheel holder and further upwards along two inclined planes of the two slide ways so as to be inserted into two recesses of the two clamp plates with two ring grooves of the wheel axle respectively engaged with two circumferential ridges of the two recesses, thus provide a quick and secure assemblage to the office chair caster without worry of coming loose after a long-termed use.

### BACKGROUND OF THE INVENTION

1. Field of the Invention

This invention relates to an office chair caster with a structural improvement, particularly to one capable of having a wheel assembled with a wheel holder quickly and securely without worry of coming loose after a long-termed use.

2. Description of the Prior Art

Generally speaking, a known conventional caster, as shown in FIG. 1, has two wheels 1, a wheel holder 2 and a wheel axle 3. Each of the two wheels 1 has a hub hole 10 extending through a center thereof. A circular recess 11 is disposed at an outer side of each of the two hub holes 10 and provided with an engagement groove 110 disposed therein. The wheel holder 2 capable of being assembled with the two wheels 1 by the wheel axle 3 has an axle hole 20 disposed at a center thereof and corresponding to the two hub holes 10 of the two wheels 1, and a spindle hole 21 disposed at a top thereof for the insertion of a steel ball 23 and a spindle 22 so that the assembled caster can swivel freely. The wheel axle 3 capable of extending through the two hub holes 10 of the two wheels 1 and the axle hole 20 of the wheel holder 2 to combine them together has two ring grooves 30 respectively disposed adjacent both ends thereof for the engagement with rings 31 and washers 32. Two caps 33 are capable of being covered around the both ends of the wheel axle 3 and further fitted in the two circular recesses 11 of the two wheels 1. Each of the two caps 33 has a circumferential ridge 330 disposed on an outer periphery thereof for being engaged with each of the two engagement grooves 110 of the two circular recesses 11.

In assembling, firstly place the two wheels 1 respectively at both sides of the wheel holder 2. Secondly, extend the wheel axle 3 through the hub holes 10 of the two wheels 1 and the axle hole 20 of the wheel holder 2. Thirdly, engage the rings 31 and the washers 32 with the two ring grooves 30 of the wheel axle 3. Finally, fit the two caps 33 respectively into the two circular recesses 11 of the two wheels 1 to make the two circumferential ridges 330 of the two caps 33 engaged with the two engagement grooves 110 of the circular recesses 11 for avoiding the two caps 33 to be loosened away from the circular recesses 11 of the two wheels 1.

However, such complicated components of the known conventional caster make the assembling work become very troublesome. Moreover, the two wheels 1 have to be designed with a particular size to be matched with the configuration of the wheel holder 2 for being assembled at the both ends of the wheel holder 2 in a symmetrical way. In addition, In case that one of the two caps 33 is not assembled securely, the two wheels 1 may have the danger of coming loose.

As can be realized from the above description, the shortcomings of such kind of known conventional casters have been presented in the existing prior arts for a long time. Therefore, the present invention is improved to create a novel and unique construction for an office chair caster to increase using efficiency.

### SUMMARY OF THE INVENTION

The main purpose of the invention is to offer an office chair caster with a structural improvement capable of having a wheel assembled with a wheel holder quickly and securely without worry of coming loose after a long-termed use.

The main feature of the invention is to provide an office chair caster with a structural improvement mainly including:

a wheel holder being integrally formed and having a spindle hole disposed at a center of a top thereof, an open slot disposed in a middle portion of a lower part thereof, and two clamp plates respectively extending downwards and disposed at both sides of the lower part thereof, the two clamp plates each provided with a recess disposed in a proper place of an inner wall surface thereof and a slide way extending downwards from the recess, each of the two recesses provided with a circumferential ridge disposed in an inner wall surface thereof, an inclined plane being formed between an upper portion of each of the two slide ways and an entrance of each of the two recesses;

a wheel capable of being placed in the open slot of the wheel holder and combined with the two clamp plates of the wheel holder, and having a through hole extending through a center thereof; and,

a wheel axle capable of being extended through the through hole of the wheel and having two ring grooves respectively and accordingly disposed adjacent both ends thereof for the engagement with the circumferential ridges of the two recesses of the two clamp plates of the wheel holder.

### BRIEF DESCRIPTION OF DRAWINGS

This invention will be better understood by referring to the accompanying drawings, wherein:

FIG. 1 is an exploded perspective view of a known conventional caster;

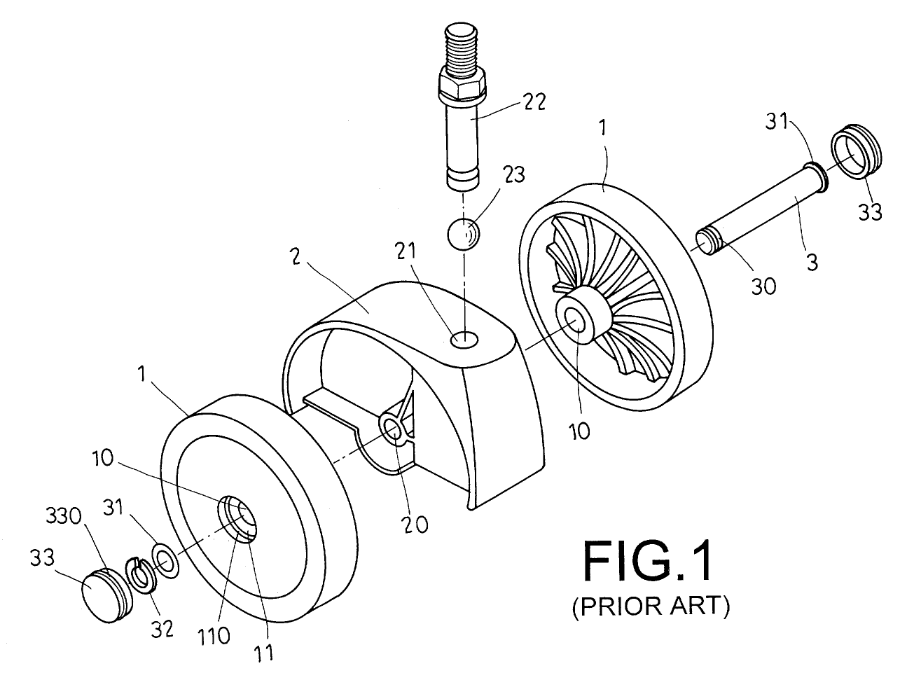

FIG. 2 is an exploded perspective view of an office chair caster with a structural improvement in the present invention;

FIG. 3 is a partial sectional view showing a wheel holder of the office chair caster with a structural improvement in the present invention; and,

FIG. 4 is a sectional view showing an assemblage of the office chair caster with a structural improvement in the present invention.

### DETAILED DESCRIPTION OF THE PREFERRED EMBODIMENT

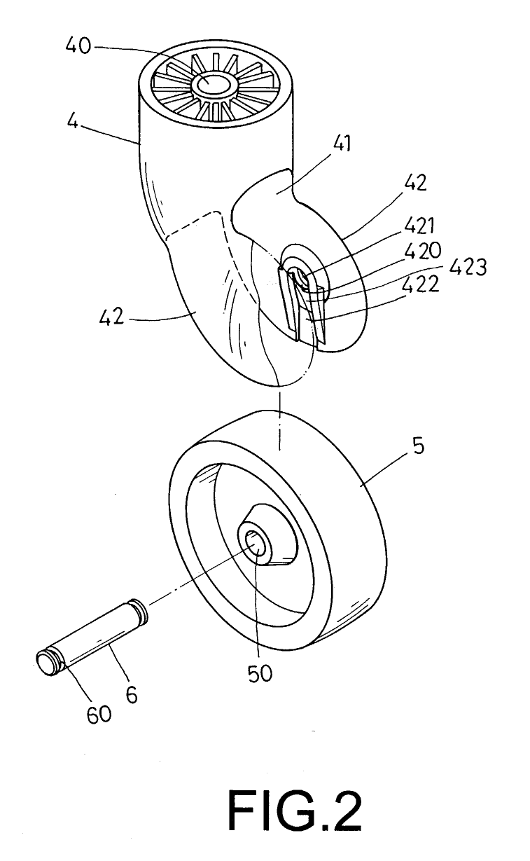

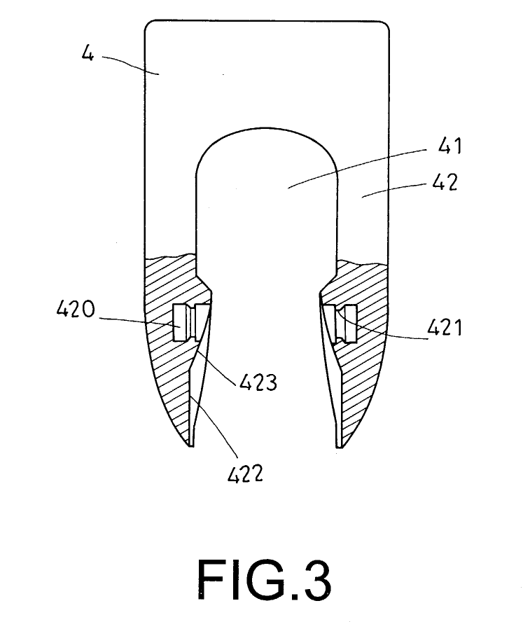

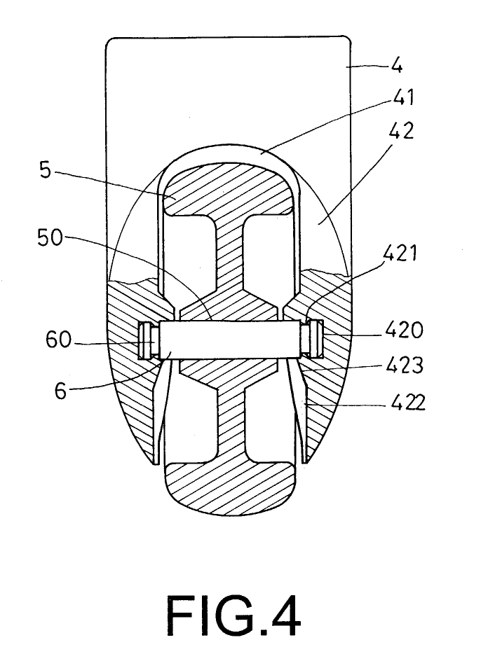

A preferred embodiment of an office chair caster with a structural improvement in the present invention, as shown in FIGS. 2 to 4, mainly includes a wheel holder 4, a wheel 5 and a wheel axle 6.

The wheel holder 4 integrally formed has a spindle hole 40 disposed at a center of a top thereof, an open slot 41 disposed in a middle portion of a lower part thereof, and two clamp plates 42 respectively extending downwards and disposed at both sides of the lower part thereof. Each of the two clamp plates 42 is provided with a recess 420 disposed in a proper place of an inner wall surface thereof and a slide way 422 extending downwards from the recess 420. Each of the recesses 420 is provided with a circumferential ridge 421 disposed in an inner wall surface thereof. An inclined plane 423 is formed between an upper portion of each of the two slide ways 422 and an entrance of each of the two recesses 420.

The wheel 5 capable of being placed in the open slot 41 of the wheel holder 4 and combined with the two clamp plates 42 of the wheel holder 4 has a through hole 50 extending through a center thereof.

The wheel axle 6 capable of being extended through the through hole 50 of the wheel 5 has two ring grooves 60 respectively and accordingly disposed adjacent both ends thereof for the engagement with the two circumferential ridges 421 of the two recesses 420 of the two clamp plates 42 of the wheel holder 4.

In assembling, referring to FIGS. 2 to 4, extend the wheel axle 6 through the through hole 50 of the wheel 5, and then place the wheel 5 in the open slot 41 of the wheel holder 4 to make the both ends of the wheel axle 6 respectively slide upwards from lower ends of the two slide ways 422 of the two clamp plates 42 of the wheel holder 4 and further upwards along the two inclined planes 423 of the two slide ways 422 to stretch the two clamp plates 42 slightly outward to help the both ends of the wheel axle 6 to be respectively inserted into the two recesses 420 of the two clamp plates 42 smoothly and quickly with the two ring grooves 60 of the both ends of the wheel axle 6 respectively engaged with the two circumferential ridges 421 of the two recesses 420, by which the wheel 5 is capable of being assembled with the wheel holder 4 quickly to make the both end of the wheel axle 6 fixed in the two recesses 420 of the two clamp plates 42 securely without using any tools, thus provide a quick and secure assemblage to the office chair caster without the slightest fear that the wheel axle 6 and the wheel 5 may be loosened away from the wheel holder 4 after a long-termed use.

The invention has the following advantages, as can be understood from the aforesaid description.

1. The components of the present invention are much less than those of the conventional caster and are capable of being assembled together easily, conveniently and quickly.

2. The assembling way by sliding the both ends of the wheel axle 6 straightly and smoothly along the two slide ways 422 of the two clamp plates 42 of the wheel holder 4 and further upwards along the inclined planes 423 of the slide ways 422 to stretch the two clamp plates 42 slightly outward for facilitating the both ends of the wheel axle 6 to be quickly inserted into and securely fixed in the recesses 420 of the two clamp plates 42 enables the office chair case of the present invention to achieve a quick and secure assemblage without the slightest fear that the wheel axle 6 and the wheel 5 may be loosened away from the wheel holder 4 after a long-termed use.

While the preferred embodiment of the invention has been described above, it will be recognized and understood that various modifications may be made therein and the appended claims are intended to cover all such modifications that may fall within the spirit and scope of the invention.

What is claimed is:

1. An office chair caster with a structural improvement comprising:
a wheel holder being integrally formed and having a spindle hole disposed at a center of a top thereof, an open slot disposed in a middle portion of a lower part thereof, and two clamp plates respectively extending downwards and disposed at both sides of said lower part thereof, said two clamp plates each provided with a recess disposed in a proper place of an inner wall surface thereof and a slide way extending downwards from said recess, each of said two recesses provided with a circumferential ridge disposed in an inner wall surface thereof, an inclined plane being formed between an upper portion of each of said two slide ways and an entrance of each of said two recesses;
a wheel capable of being placed in said open slot of said wheel holder and combined with said two clamp plates of said wheel holder, and having a through hole extending through a center thereof;
a wheel axle capable of being extended through said through hole of said wheel and having two ring grooves respectively and accordingly disposed adjacent both ends thereof for the engagement with said circumferential ridges of said two recesses of said two clamp plates of said wheel holder; and,
whereby extend said wheel axle through said through hole of said wheel, and then place said wheel in said open slot of said wheel holder to make both ends of said wheel axle respectively slide upwards from lower ends of said two slide ways of said two clamp plates of said wheel holder and further upwards along said inclined planes of said two slide ways of said two clamp plates so as to be inserted into said two recesses of said two clamp plates with said two ring grooves of said two wheel axle respectively engaged with said two circumferential ridges of said two recesses, thus provide a quick and secure assemblage to said office chair caster without the slightest fear that said wheel axle and said wheel may be loosened away from said wheel holder after a long-termed use.
